(19) United States
(12) Patent Application Publication
(10) Pub. No.: US 2002/0081355 A1
(43) Pub. Date: Jun. 27, 2002

(54) Packaging wrap for meat products

(75) Inventor: Ekkehardt Schafer, Karlsruhe (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: World-Pac International AG

(21) Appl. No.: 09/749,013

(22) Filed: Dec. 27, 2000

(51) Int. Cl. A23G 1/00

(52) U.S. Cl. 426/132

(57) ABSTRACT

A packaging wrap is provided for meat products, in particular for boiled ham or pickled products, wherein the packaging wrap is insoluble in water, suitable for a cooking process, and comprises a foil that is permeable to gas, steam and/or smoke. Against the side of the foil facing away from the meat product, a net can be placed to increase its strength. The foil comprises a thin-walled fibrous foil having a maximum area weight of about 120 g/m² and an anti-adhesive coating on its side facing away from the meat product. The anti-adhesive coating is made of a material that is safe in accordance with food packaging regulations and prevents the meat product from binding with the packaging wrap during the cooking process.

### BACKGROUND OF THE INVENTION

The invention relates to a packaging wrap in the form of a non-tubular, flat foil for meat products, in particular boiled ham and pickled products, wherein the packaging wrap is insoluble in water, is suitable for a cooking process, and comprises a foil which is permeable to gas, steam and/or smoke. Against the side of the wrap facing away from the meat product, a net is placed to increase its strength.

To produce a boiled ham or a boiled pickled product with an elastic or rigid net, a foil is required which is placed between the meat product and the net to prevent the meat albumin from adhering to the net during the cooking process. For this purpose, edible collagen foils are used nowadays.

However, the use and processing of these collagen foils is problematic in more than one respect. On the one hand, the collagen foil has only a weak tear strength and even less tear propagation resistance. Hence, minor damage results in a growing tear in the foil. On the other hand, collagen foil can only be processed under very limited moisture and temperature conditions. In addition, it must be stored and processed at great expense in air-conditioned rooms.

It is often also desired that the foil be perforated so that air pockets, which form under the foil during the cooking process, can escape. This perforation is impossible due to the low tear propagation resistance of collagen foil. Rather, the finished product must instead be pricked by hand after application of the net.

Not last, the edible collagen foil has a tough bite, which has a negative effect on the consumer.

### BRIEF SUMMARY OF THE INVENTION

Proceeding from this background, an object of the present invention is to provide a new flat foil, which is suitable for boiled ham or boiled pickled products without exhibiting the aforementioned disadvantages of collagen foils. In particular, the foil according to the invention should be distinguished by an non-problematic storage and processing as well as by comparatively favorable manufacturing costs.

According to the invention, this object is achieved in that the foil is constructed as a thin-walled fibrous foil having a maximum area weight of approximately 120 g/m², preferably a maximum of about 100 g/m², and has an anti-adhesive coating on its side facing the meat product. The anti-adhesive coating comprises a material that is safe in accordance with food packaging regulations and prevents the meat product from adhering to the packaging wrap.

The fibrous foil according to the invention no longer need be stored under special temperature and moisture conditions, as is absolutely necessary with collagen foils. Moreover, it has a substantially higher tear strength and thus a very good machine runability. In addition, due to its high strength, it can also be used already pricked or perforated, so that air pockets formed between the meat product and foil during the cooking process can escape without difficulty.

As a result of its anti-adhesive coating on the inside, which can comprise viscose, silicone, wax or polyethylene, or optionally mixtures hereof, it is ensured that it does not bind itself with the albumin of the meat product during cooking. Thus, it can be effortlessly removed together with the net from the meat product after cooking, without thereby tearing small pieces out of the surface of the meat product. The consumer thus receives a product which is free from packaging foil and has a perfect appearance.

### DETAILED DESCRIPTION OF THE INVENTION

Synthetic intestines having an anti-adhesive coating are, in fact, already known. However, this is a very stiff and relatively thick-walled starting material, which is only suitable for sausages but not for piece products such as ham.

Preferably, the outer fibrous foil of the present invention alone has an area weight of about 3 to 80 g/m², preferably about 8 to 20 g/m². As a result, it is highly flexible and also perfectly suitable for coarse-pieced products. For the same reason, one also works with extremely low area weights for the anti-adhesive coating, namely about 0.5 to 100 g/m², preferably about 1 to 50 g/m², and most preferably about 1 to 10 g/m². On the whole, the packaging wrap thus has preferably a maximum area weight of about 50 g/m².

To prevent any adhesion whatsoever of the meat product with the packaging wrap, it is advantageous if the anti-adhesive coating completely covers the fibrous foil. However, it is also within the scope of the invention to work only with a predominent coating, so that only minimal areas remain where the meat product could come into contact with the foil.

Several possibilities are conceivable to ensure the water impermeability of the packaging wrap, which prevents the meat product from leaking:

On the one hand, the fibrous foil may be impermeable to water.

Alternatively, when using a water-permeable fibrous foil, the anti-adhesive coating can be impermeable to water. In this case, the anti-adhesive coating should cover the fibrous foil completely, for only then is it guaranteed that no water can penetrate through coating gaps in the packaging wrap or that no meat juice can escape from the packaging wrap. However, a certain water permeability—perhaps due to perforation—can, for the most part, be tolerated.

Finally, it is also conceivable that both the anti-adhesive coating and the fibrous foil are impermeable to water. This then has the advantage that small damages to either the fibrous foil or the coating cannot lead to the entire packaging wrap becoming water permeable.

To ensure that the packaging wrap is permeable to gas, steam and/or smoke, it is expedient if both the anti-adhesive coating and the fibrous foil are permeable to gas, steam and/or smoke.

Alternatively, however, an anti-adhesive coating that is impermeable to gas, steam and/or smoke can be used, if a sufficient number of gaps are provided in this coating. These gaps then guarantee that the gases occurring during the cooking process can escape through them, despite the impermeability of the coating itself. Such coating gaps are particularly expedient if the anti-adhesive coating is made of wax or polyethylene, since these materials are essentially impermeable to gas, steam and smoke.

However, in this connection, it should be noted that even these materials which are impermeable to gas and smoke become permeable again, if the layer thickness of the antiadhesive coating constructed from these materials is sufficiently thin, since, as is known, the gas, steam and smoke permeability of a material depends on the layer thickness used.

With respect to the application of the anti-adhesive coating to the fibrous foil, it is advantageous if it is pressed, rolled, brushed or pasted on, since these processes can be carried out in a simple and cost-effective manner. When pasting the anti-adhesive coating onto the foil, care should be taken that an adhesive is used that is safe in accordance with food packaging regulations.

The fibrous foil used for the packaging wrap can expediently be a woven, knit, fleeced or non-woven fabric, for example made of cellulose, staple fiber, cotton, polyethylene, polypropylene, and/or polyamide. Furthermore, of course, a mixture of these materials is conceivable. The foil can also have a certain elasticity throughout.

With respect to the “net” that lies under its own tension against the side of the packaging wrap facing away from the meat product, this term refers to any type of material that essentially fulfils two requirements:

It must be tear resistant in order to ensure a protective property for the fibrous foil. Furthermore, it should preferably be permeable to gas, steam and smoke, so that the meat products therein can be properly aged, stored, cooked and smoked. For this purpose, one can resort to known products.

With respect to the process for manufacturing the packaging wrap according to the invention, it is advisable that the anti-adhesive coating be applied to the foil in a flat state, for example either by a coating plate (master knife) or by means of a printing machine with a rotogravure cylinder. Both processes can be carried out in a considerably more cost-efficient manner than the application onto a tubular wrapping material.

The net under considerable pretension is them pulled over the meat product enclosed in the foil prior to the cooking process.

The invention will be explained in the following with reference to an embodiment of a packaging wrap according to the invention for boiled ham:

The packaging wrap comprises a very thin cellulose fibrous foil having an area weight of 17 g/m² and which is permeable to both gas and steam and also, to a great extent, to smoke.

An anti-adhesive coating made of viscose and having an area weight of 5 g/m², which is likewise permeable to gas, steam and smoke, is applied by a cylindrical coating machine over the entire surface of the side of the foil facing the meat product in the filled state. This viscose coating provides an especially good peelability of the packaging wrap from the meat product, and at the same time it improves the further tear resistance of the foil.

The foil is then wrapped about the boiled ham in such a manner that the edges of the foil slightly overlap. An elastic net, which is known per se, is then spread open and stretched over the ham packed in the foil.

After the cooking process, the foil is removed together with the net.

Moreover, it can advantageously be provided that the coating is impregnated with coloring agents, liquid seasonings, liquid flavors, liquid smoke, or the like, which are transferred to the meat product during the cooking process. It is also within the scope of the invention to imprint the foil with an edible color, which is then transferred to the product during cooking.

The present invention makes available a packaging wrap for meat products to be cooked, which is easy to handle, cost-efficient to manufacture, and which can be effortlessly removed from the meat product after the cooking process.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A packaging wrap for meat products, in particular for boiled ham or boiled pickled products, comprising a non-tubular, flat foil, which is insoluble in water, suitable for a cooking process, and permeable to gas, steam and/or smoke, against whose side facing away from a meat product to be packaged therein can be placed a net for increasing strength, wherein the foil is configured as a thin-walled fibrous foil having a maximum area weight of about 120 g/m² and the foil having an anti-adhesive coating on its side facing the meat product, the anti-adhesive coating comprising a material that is safe in accordance with food packaging regulations and prevents the meat product from binding with the packaging wrap.

2. The packaging wrap according to claim 1, wherein the fibrous foil has an area weight of about 3 to 80 g/m².

3. The packaging wrap according to claim 1, wherein the anti-adhesive coating comprises a material selected from the group consisting of viscose, silicone, wax, and polyethylene.

4. The packaging wrap according to claim 1, wherein the anti-adhesive coating has an area weight of about 0.5 to 100 g/m².

5. The packaging wrap according to claim 1, wherein the anti-adhesive coating at least predominantly covers the fibrous foil.

6. The packaging wrap according to claim 1, wherein at least one of the anti-adhesive coating and the fibrous foil is water impermeable.

7. The packaging wrap according to claim 1, wherein the anti-adhesive coating is permeable to gas, steam and/or smoke.

8. The packaging wrap according to claim 1, wherein the anti-adhesive coating is impermeable to gas, steam and/or smoke and has gaps provided therein.

9. The packaging wrap according to claim 1, wherein the anti-adhesive coating is pressed, rolled, brushed or pasted on.

10. The packaging wrap according to claim 1, wherein the fibrous foil is selected from the group consisting of woven, knit, fleeced, and non-woven fabrics.

11. The packaging wrap according to claim 1, wherein the fibrous foil comprises fibers selected from the group consisting of cellulose fibers and synthetic fibers, which are processed into a woven, knit, fleeced or non-woven fabric.

12. The packaging wrap according to claim 1, which is pricked or perforated.

13. The packaging wrap according to claim 1, which is impregnated with a material selected from the group consisting of liquid seasonings, liquid flavors and liquid smoke.

14. The packaging wrap according to claim 1, which is imprinted with edible color.

15. A process for manufacturing a packaging wrap in a form of a non-tubular, flat foil for meat products, in particular for boiled ham or pickled products, the packaging wrap being insoluble in water, suitable for a cooking process, and comprising a foil that is permeable to gas, steam and/or smoke, against whose side facing away from a meat product to be packaged therein a net can be stretched to increase its strength, the method comprising selecting a fibrous foil having an area weight of about 15 to 100 g/m² and applying an anti-adhesive coating to at least one side of the foil, the anti-adhesive coating comprising a material that is safe in accordance with food packaging regulations, and the coating preventing the meat product from binding with the packaging wrap during a later cooking process.

16. The process according to claim 15, wherein the anti-adhesive coating is applied to the foil in a flat state.

17. The process according to claim 15, wherein the anti-adhesive coating is applied by a coating plate or by a cylindrical coating machine.

18. The process according to claim 15, wherein the anti-adhesive coating is applied to the foil by a printing machine having rotogravure cylinder.
